(19) United States
(12) Patent Application Publication
(10) Pub. No.: US 2002/0044635 A1
(43) Pub. Date: Apr. 18, 2002

(54) LEAST COST CALL ROUTING

(76) Inventor: JOHN KLUG, EVERGREEN, CO (US)

Correspondence Address: DORSEY & WHITNEY, LLP, SUITE 4700, 370 SEVENTEENTH STREET, DENVER, CO, 80202-5647, US

(21) Appl. No.: 09/406,993

(22) Filed: Sep. 28, 1999

Related U.S. Application Data
(60) Provisional application No. 60/102,129, filed on Sep. 28, 1998.

(51) Int. Cl. H04M 15/00

(52) U.S. Cl. 379/114.02

(57) ABSTRACT

The least call routing system assists the public in call routing by analyzing the available call routing options in relation to user specific criteria so as to identify an appropriate carrier. In one embodiment, a number of users (101-106) and a number of carriers (110, 112 and 114) are interconnected to a call routing selection site (106) via the internet (108). The selection site (116) includes a processor (118), a service information database (120) and a user information database (122). The service information database (120) includes a calling plan or other call rating information for each of the carriers (110, 112 and 114). The user information database (122) includes information specific to particular users that may be relevant to selecting a preferred routing option or carrier. The processor (118) is operative for accessing the service information database (120) and the user information database (122) so as to select a preferred carrier or routing option based on the available carrier options and user preferences or other user information.

### REFERENCE TO RELATED APPLICATION

This application claims priority from U.S. Provisional patent application No. 60/102,129 filed on Sep. 28, 1998.

1. Field of the Invention

The present invention relates in general to communications system routing and, in particular, to a method and apparatus for assisting communications system users, including residential and home office users, in selecting as between carriers to obtain the best rate, best service or combination thereof.

2. Background of the Invention

Communications systems utilized by the public, including residential and home office users, include: Plain Old Telephone Service (POTS) systems and their protocol derivatives such as ISDN, DSL, etc.; Cable; Satellite C band, ku band, small aperture, etc.); Radio; cellular and PCS; and paging. Access to those systems is a major expense for both residential and business users. Such access may involve paging or beeper service, internet access via an ISP (using telephone/cable/microwave or satellite), telephone calls (local, interLATA, long distance and international), 800/888 service, cellular or PCS service and calling cards. It would be desirable to reduce the expense associate with such services while maintaining a desired service quality.

With increased competition among carriers or providers of such services, a variety of service and pricing options are generally available. Indeed, hundreds of companies (if not more) offer such services and their rates and features change overtime, sometimes by the day and even the hour. The quality of service also varies from carrier to carrier. Given this range of options and the dynamic nature of the market, it is difficult or impossible for the public, including residential and home office users, to comparison shop to select the best routing options.

### SUMMARY OF THE INVENTION

The present invention assists the public in call routing by analyzing the available call routing options in relation to user specific criteria so as to identify an appropriate carrier. For purpose of convenience, the term “call” is used herein to generically refer to telephone calls, paging, internet access and other communication system services. In this manner, the public is enabled to effectively comparison shop and thereby realize many of the potential benefits of increased competition among carriers.

In accordance with one aspect of the present invention, a processing system is provided for analyzing call routing options in relation to user specific criteria. Such criteria may include service preferences entered by the user such as least cost, best service (e.g., sound quality and/or connection availability), or least cost available for a given quality standard/communications system type (e.g., least cost POTS carrier, least cost wireless, least cost digital wireless, least cost for a specified bandwidth/connection speed). Alternatively, the criteria may be derived from a user profile based on a history of system usage. The criteria may be applied on a call by call or aggregated basis, and may be periodically or occasionally updated as desired. The processing system accesses a database of available service options based on the user specific criteria to identify a suitable service provider for a call/system access or for a service period. A preferred or “best” available option can thereby be selected for a particular user based on cost and other criteria.

In accordance with another aspect of the invention, a user is notified of a preferred call routing option for the user such that the user can manually select the preferred option. The associated method includes the steps of: providing a routing selection system for receiving service information regarding multiple carriers and for receiving routing preference information regarding a particular user; operating the routing selection system to select a preferred carrier based on the service information and the routing preference information; and providing routing information regarding the preferred carrier to the particular user.

The service information may include calling plan and other rating information and is preferably provided by the various carriers on a regularly updated basis. In this regard, carriers may be motivated to provide updated information as available in order to compete more effectively. The routing preference information may include any of the user specific criteria noted above and may be provided by the user or obtained from other sources. The user may be notified of a preferred carrier or carriers via e-mail or other data network contact, via phone, via fax, via regular mail or other suitable fashion. Such notifications may be provided on a regular basis, at specified intervals or in response to changing market conditions.

An associated business method derives revenues from the carriers and/or users based on use of the routing notification system. In this regard, the routing system may be embodied, for example, as a server system at a web site. The routing system can then receive routing preference information and service information via the internet. Users may pay for the service on a subscription basis. Additionally or alternatively, fees may be paid by a carrier when a user selects the carrier based on a notification by the routing notification system Additional potential sources of revenue include advertisements at the web site or pushed to the user in connection with notifications or otherwise.

In accordance with another aspect of the present invention, a call routing system is interfaced with a telephone system so as to automatically or substantially automatically select a preferred carrier on a call by call basis. It has been recognized that the calling rates available from particular carriers change frequently and may be dependent on the location called and other factors. Accordingly, call routing can be more fully optimized if implemented in a call by call basis. The associated method includes the steps of: interfacing a call routing processor system with a phone system; using the processor system to receive a call request from the phone system and identify at least one call parameter related to the request; analyzing a number of call routing options based on the call parameter to identify a preferred call routing option; and routing the call request in accordance with the preferred call routing option. The call parameter may be related to the called number, called location, called area code, call time, call day or date, or other service parameter. The processor system may be resident in the phone or phone network, in a separate computer or computer network at the user's residence/business, or at a separate location interconnected to the phone via a public or private computer network. Routing the call may involve dialing a carrier access number or prefixing a carrier access number to the dialed number of the call request. The call may be routed automatically via a “best” routing option or the user may select from a menu of acceptable options. In this manner, call routing can be optimized via a system that is substantially transparent to the user.

### BRIEF DESCRIPTION OF THE DRAWINGS

For a more complete understanding of the present invention and further advantages thereof, reference is now made to the following detailed description taken in conjunction with the drawings, in which:

FIG. 1 is a schematic diagram of a network implementing a call routing processing system in accordance with the present invention;

FIG. 2 is a schematic diagram of a further call routing system in accordance with the present invention; and

FIG. 3 is a flow chart illustrating call routing processes in accordance with the present invention.

### DETAILED DESCRIPTION

In the following description, the invention is set forth in the context of various call routing systems for assisting users in selecting a preferred carrier for telephone calls. Although the invention is set forth in the context of carriers for telephone networks, it will be appreciated that the system of the present invention is more broadly applicable to a variety of communication system services.

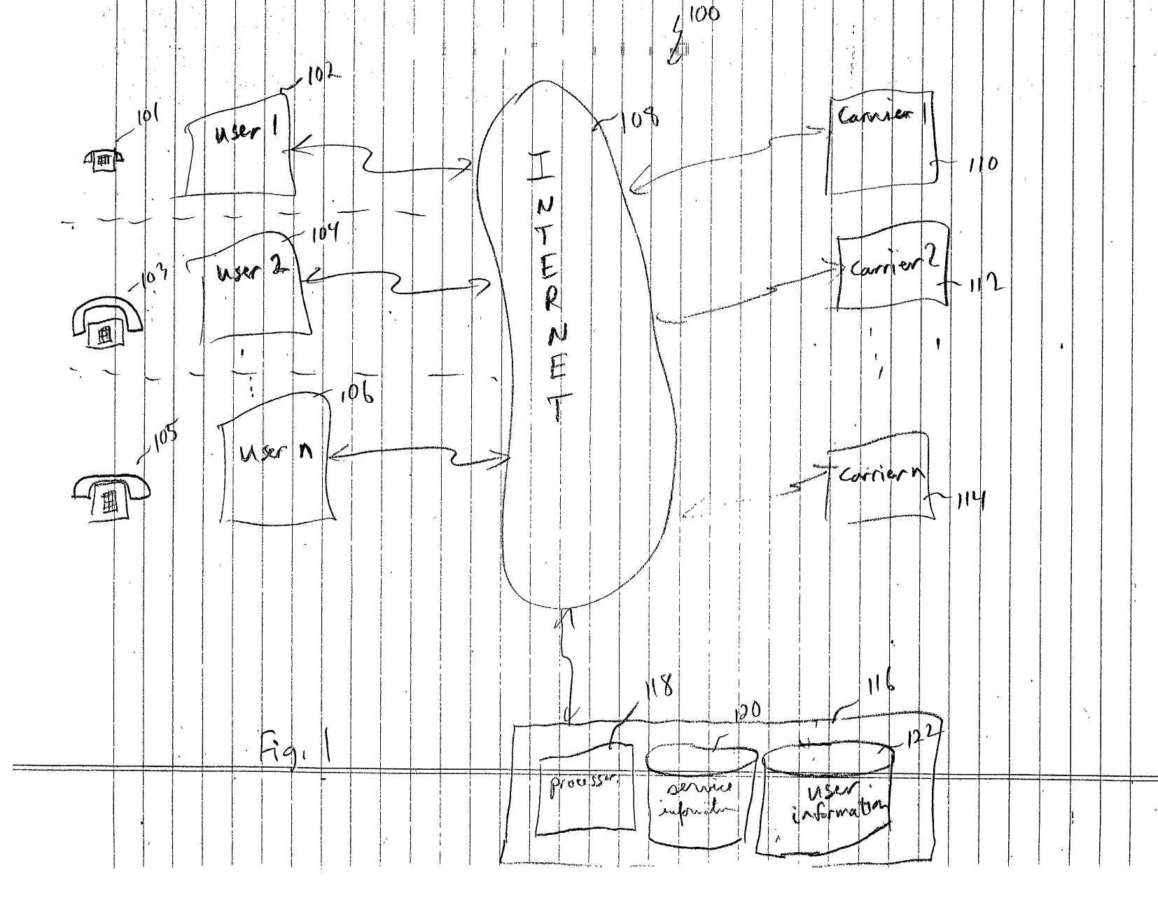

Referring to FIG. 1, a network implementing a call routing system in accordance with the present invention is generally identified by the reference numeral 100. In particular, FIG. 1 illustrates an implementation of the present invention where users are notified of preferred carriers for telephone services such that the users can manually select a preferred carrier. In the illustrated network 100, a number of users 101-106 and a number of carriers 110, 112, and 114 are interconnected to a call routing selection site 106 via the internet 108. More specifically, in the illustrated system, each user location includes a telephone 101, 103 or 105 for placing telephone calls via a telephone network and a user node 102, 104 or 106 of the internet 108. The carriers 110, 112 and 114 in the illustrated implementation are alternate carriers of the telephone network.

The illustrated selection site 116 includes a processor 118, a service information database 120 and a user information database 122. The service information database 120 includes a calling plan or other call rating information for each of the carriers 110, 112 and 114. It will be appreciated that such information may include rating information that is dependent on the time of the call, the duration of the call, the locations of the called and calling phones, the date, the hour, and any other parameters that are relevant to determining a rate for a call. In addition, the service information database 120 may include information regarding the sound quality, reliability, availability of lines and the like for each of the carriers 110, 112 and 114. For example, for a given call, it may be possible to establish a communications link via a POTS network or a protocol derivative network such as ISDN or DSL networks. However, such options may involve trade offs relating to sound quality, reliability and availability of lines.

The user information database 122 includes information specific to particular users that may be relevant to selecting a preferred routing option or carrier. Such user information may include selection criteria entered by the user. For example, the user may specify a preference for the least cost routing option regardless of service quality or other parameters. Alternatively, the user may specify a preference for the highest reliability or availability of lines regardless of cost. Moreover, the user may specify a preference for the least cost routing option that meets specified service quality standards.

Additionally, the user information database 122 may include information regarding particular users that is obtained from other sources. For example, the user information may include a user profile derived from a network usage history. This profile can be used to select a least cost or otherwise preferred carrier based on the users calling patterns.

The processor 118 is operative for accessing the service information database 120 and the user information database 122 so as to select a preferred carrier or routing option based on the available carrier options and user preferences or other user information. For example, if a user desires to identify the least cost carrier based on a user's calling patterns, the processor can access the user information database 122 to retrieve a user profile, access the Service information database 120 to obtain rating information for each of the carriers 110, 112 and 114 and then analyze the user profile in relation to the rating information to identify a preferred carrier or carriers. A similar analysis can be performed with regard to reliability, availability of lines or combinations of service parameters.

Once a preferred carrier or carriers have been identified, the user can be notified by various mechanisms. For example, a notification can be sent to the user by regular mail, fax, phone, or electronically. In the illustrated implementation, the user nodes 102, 104, and 106 can receive notifications from the selection site 116 via e-mail. In this manner, the users can obtain timely notifications. Such notifications may be sent to the users on an occasional or periodic basis, as requested by the users, or in response to changes in the marketplace.

Various revenue models are possible in connection with the illustrated system. In this regard, the operator of the site 116 may receive fees from each of the users 102, 104 and 106 on a subscription basis. Additionally or alternatively, the operator of the site 116 may receive fees from the various carriers 110, 112 and 114 when a user selects the carrier 110, 112 or 114 in response to a notification from the site 116. Moreover, the operator of the site 116 may generate revenues based on advertisements at the site 116 or pushed to the user nodes 102, 104 and 106 in connection with notifications or otherwise.

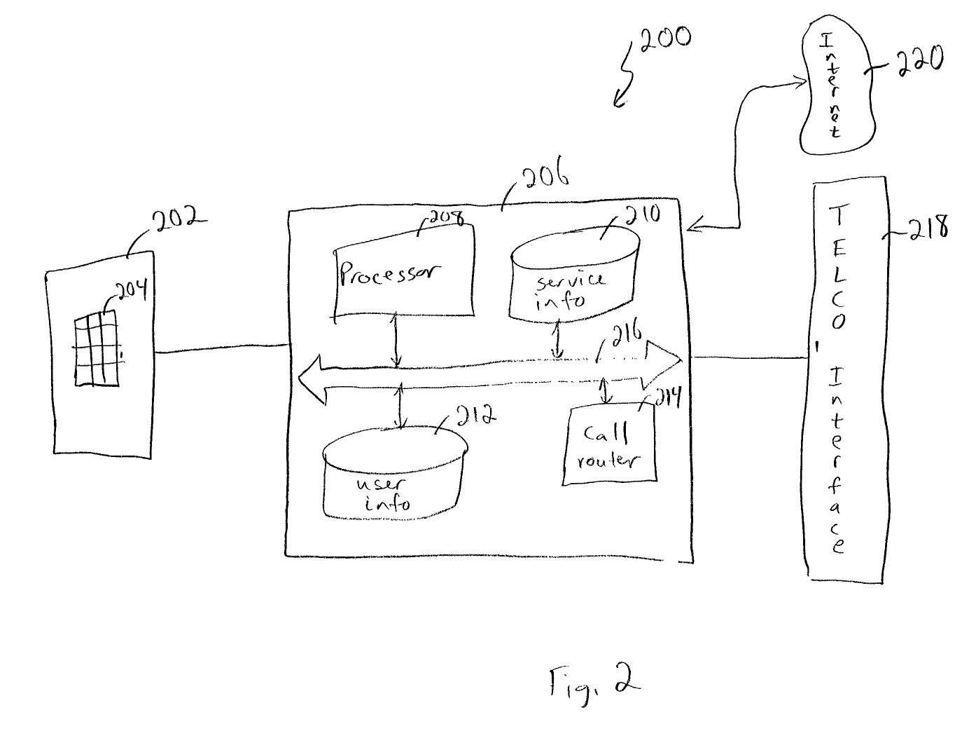

FIG. 2 illustrates a call routing system 200 that allows for automatic or substantially automatic call routing via preferred call routing options/carriers. The system 200 includes a user phone 202, a processor system 206 and a telephone company interface 218. As shown, the processing system 206 is interposed between the phone 202 and the interface 218 so as to analyze call requests and selectively route the call request in accordance with preferred routing options. In this regard, a call request is entered on the phone 202, for example, by entering a called phone number on the keypad 204.

The call request is then transmitted to the processor system 206. The processing system 206 includes a processor 208, a service information database 210, a user information database 212 and a call router 214, all interfaced via a database 216. The service information database 210 and the user information database 212 include rating and service quality information as well as user specific information (e.g., service preferences and a user profile) as discussed above. In this regard, the service information may be updated based on information received from the various service providers via the internet 220. The illustrated processing system 206 may be embodied as a computer or computer network resident at the user's premises or may be implemented at a separate site interconnected to the user premises via a computer network.

The processor 208 receives the call request and analyzes the call request to obtain information relevant to selecting a preferred call routing option. Such information may include the time of the call, the date of the call, and a location of the called telephone. In response to the call request, the processor accesses the service information database 210 and the user information database 212 to identify a preferred routing option or options as discussed above. Once a preferred calling option is identified, the call router 214 is utilized to route the call request to the called telephone via a preferred call routing option/carrier. In this regard, the call router may be operative to dial a carrier access number by generating appropriate dial tones, or the call router may attach an appropriate prefix to the called number and retransmit the prefix and called number so as to route the call request to the called telephone via a preferred carrier. Such dial around prefixes are well known and are listed, for example, at www.abelltolls.com. Optionally, upon identifying more than one preferred routing option, the processor may provide a menu of calling options from which the user can select, e.g., by way of an appropriate entry on the keypad 204.

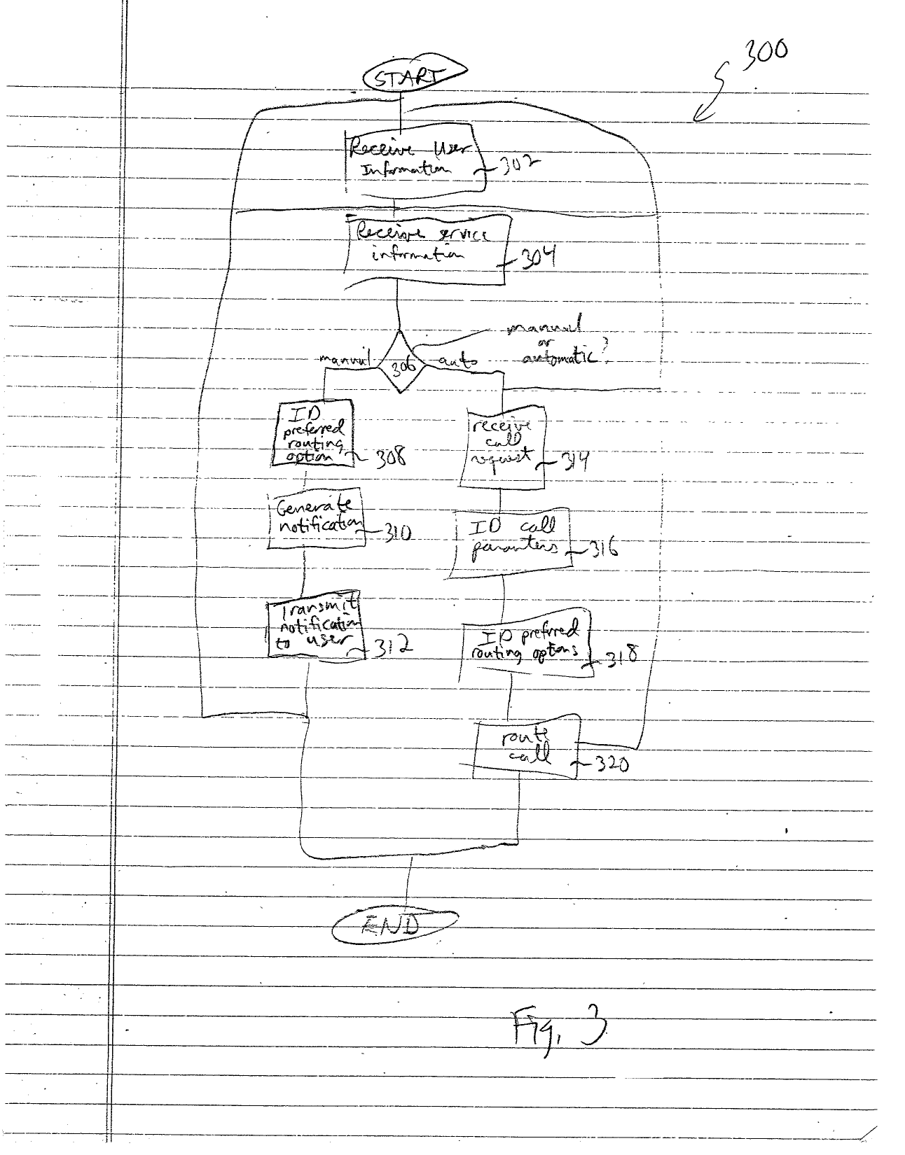

FIG. 3 is a flowchart illustrating call routing methods 300 in accordance with the present invention. The methods 300 are initiated by receiving (302) user information. As noted above, the user information may be received directly from a user or from external sources such as records of network usage. The call routing system further receives (304) service information regarding various call routing options or carriers. This service information may include rating information and quality of service information for the various carriers and may be obtained directly from the carriers or from other sources. Both the user information and service information may be updated from time to time.

Further processing depends on whether the call routing system is implemented manually or automatically. As generally indicated by decision block 306. In the manual case, further processing is conducted by identifying (308) a preferred routing option, generating (310) a notification and transmitting (312) the notification to the user. As noted above, the preferred routing option may be identified based on criteria entered by the user relating to rating and service quality preferences. The notification may be transmitted to the user by mail, fax, phone, electronically or in any other suitable fashion.

In the automatic case, further processing is initiated in response to a receiving (314) a call request. For example, the call request may be transmitted to a processing system upon completion of dialing a called phone number. In response to the call request, the processing system identifies (316) call parameters that may be relevant to selecting a preferred routing option. Such call parameters may relate to the time of the call, the date of the call, the locations of the called and calling telephones or other parameters. Based on the call parameters as well as user information and service information, the processing system then identifies (318) a preferred routing option or options and routes (320) the call. Such routing can thereby be implemented substantially transparently from the user while allowing for selection of preferred routing options and substantially real time.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed is:

1. A method for use in reducing the costs associated with telephone usage, comprising the steps of:
providing a routing selection system for receiving service information regarding multiple carriers and receiving routing preference information for a particular user;
operating the routing selection system to select a preferred carrier based on the service information and the routing preference information; and
after selecting said preferred carrier, performing one of the following steps:
a) providing routing information regarding said preferred carrier to said particular user; and
b) routing a call using said preferred carrier.
